(19) United States
(12) Patent Application Publication
(10) Pub. No.: US 2011/0154260 A1
(43) Pub. Date: Jun. 23, 2011

(54) METHOD AND APPARATUS FOR DISPLAYING INFORMATION IN AN ELECTRONIC DEVICE

(75) Inventors: GENG WANG, CHICAGO, IL (US); SHEILA A. FOLEY, Naperville, IL (US); RYAN A. POWELL, Seattle, WA (US)

(73) Assignee: MOTOROLA INC, LIBERTYVILLE, IL (US)

(21) Appl. No.: 12/640,619

(22) Filed: Dec. 17, 2009

(51) Int. Cl. G06F 3/048

(52) U.S. Cl. 715/823; 715/828

(57) ABSTRACT

A method and apparatus includes an electronic device that displays 110 a plurality of members on a first portion of a display and receives 115 a first input on the first portion of the display, wherein the input selects a first member from the plurality of members. Then, the electronic device enlarges 120 the first member and displays 130 additional information associated with the first member on the first portion of the display. After the selection, the device determines 135 if the received input is an entry input. If the input is determined to be an entry input, then detailed information associated with the first member is displayed 140 on a second portion of the display.

### FIELD OF THE DISCLOSURE

The present disclosure relates generally to displaying information on a display of an electronic device and more particularly to a method and an apparatus for displaying a set of members and information related to each member of the set of members.

### BACKGROUND

Among conventional methods of displaying information associated with a set of items, a common method is displaying summary information and allowing a user to select one item based on the summary information displayed. For example, contact information can be listed alphabetically by names-only, or audio MP3 files can be listed alphabetically by titles-only. In such a case, an electronic device often includes an input mechanism to help the user navigate through the user interface such as: arrow and enter keys of a keyboard; a pointing device such as a mouse, stylus, or trackball; a directional pad (D-pad); or a touch screen. The user selects the summarized item using the input mechanism and receives more detailed information regarding the selected item. For example, after a contact name is selected, the name, email addresses, phone numbers, and postal addresses of the contact are displayed. As another example, after an audio file title is selected, the title, album, artist, release date, and play duration are displayed.

With electronic devices having smaller displays, or with electronic devices displaying a large number of items, navigating through a sequential set of summarized items can become disjointed and confusing. Further, navigating through various summarized items in the sequential set can be cumbersome.

Accordingly, there is an opportunity to develop a method and apparatus for displaying information on a display for easy multi-level navigation, convenient viewing of the displayed summary and detailed information, and quick understanding of the sequential relationship among displayed items.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows a flowchart 100 for displaying information on a display in accordance with some embodiments.

FIG. 2 illustrates screen views 210, 220, 230, 240, 250 demonstrating an exemplary process for displaying information on a display in accordance with some embodiments.

FIGS. 3-4 illustrate screen views 310, 410 demonstrating various methods of displaying information on a display in accordance with some embodiments.

FIG. 5 illustrates screen views 510, 520, 530 demonstrating an exemplary process for displaying information on a display in accordance with some embodiments.

FIG. 6 illustrates screen views 610, 620, 630 demonstrating an exemplary process of displaying information on a display in accordance with some embodiments.

FIG. 7 illustrates screen views 710, 720, 730 demonstrating an exemplary process of displaying information on a display in accordance with some embodiments.

FIG. 8 shows a block diagram 800 of an electronic device for displaying information in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method for displaying information in an electronic device displays a plurality of members on a first portion of a display and receives a first input selecting a first member from the plurality of members. In one example, the first member is selected by default (e.g., by an application programmatically). In another example, the first member is selected by receiving a user input. Then, the electronic device enlarges the first member and displays additional information associated with the first member on the first portion of the display. “Additional information” provides other information associated with the first member that was not displayed when the plurality of members was previously displayed. Additional information associated with a member can be an information set that gives a preview of the detailed information associated with the member.

After the selection, the device determines if the received input is an entry input or a selection input. It should be noted that a person with ordinary skill in the art would understand the entry input to be a “commitment to selection”. A selection input is an input which is used to select a member and display only the additional information (second-level) associated with the selected member, and an entry input is used to display detailed information (third-level) associated with a member in addition to the additional information (second-level). Currently, some input mechanisms are able to present different interaction states regarding a user input with pointing devices. For example, when the user is using a mouse or some types of capacitive touch screens, the user interaction is able to track proximity or position of the pointing device (also known as “hover”) as well as a commitment to selection (also known as “click” or “tap”). For example, in a touch-screen embodiment, sliding a finger over a member (on the touch screen) without a touch action is considered a selection input and a touch action on the touch-screen is considered to be an entry input. Other examples of selection input and entry input are single tap and double tap (with a finger or stylus), mouse-over and click of the mouse, navigating to the various members using the arrow keys on the keypad and then pressing an ENTER key, navigating to the various members using a trackball, joystick, or D-pad and pressing the ENTER key, and focusing on a member using a TAB key and pressing the ENTER key.

Then, if the input is determined to be an entry input, detailed information associated with the first member is displayed on a second portion of the display. “Detailed information” has other information associated with the first member that was not previously displayed when the plurality of members was first displayed or when the additional information was displayed on the first portion of the display. The detailed information associated with the first member can be all the information associated with the first member that is currently saved in the electronic device and is accessible by the active software application. If, however, the device determines that the received input is not an entry input (for example, the user is just pointing the mouse over an item without clicking on it), then the device does not display the detailed information associated with the first member. As a result, a user can easily navigate to different members of the plurality of members and view information associated with various members.

An apparatus for displaying information in an electronic device includes a display having a first portion and a second portion, a user input component, and a processor. The processor is coupled to the display and the user input component. The processor includes a user input receiver, an enlarge member element, an additional information retriever, and a detailed information retriever. The user input receiver receives a user input that selects a first member from a plurality of members displayed on the first portion of the display. The user input receiver also determines if the user input is an entry input. The enlarge member element enlarges the first member on the display. The additional information retriever retrieves additional information associated with the first member from a memory and displays the retrieved additional information on the first portion of the display. The detailed information retriever retrieves detailed information associated with the first member from the memory and displays the retrieved detailed information on the second portion of the display, if the user input is an entry input. As a result, using the apparatus, a user can view multiple layers of information associated with various members.

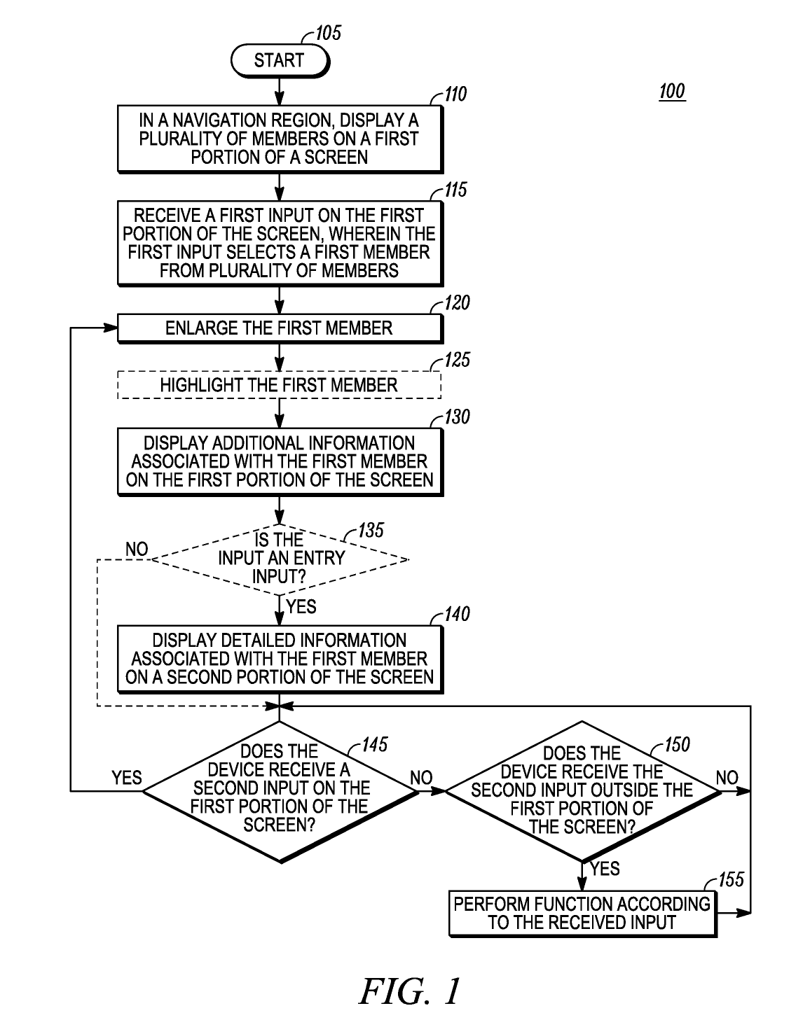

FIG. 1 is a flowchart 100 for displaying information on a display in accordance with some embodiments. The method commences 105 with the user invoking a software application that displays a first-level list of information. A first-level list of information has one or more elements with more detailed information (i.e., at least a second level of information), but this more detailed information is not shown—generally due to screen size constraints. There may be more than two levels of information, with a hierarchy according to levels. Some examples of such applications may include a calendar, a contact list, a photo gallery, a navigation guide, an electronic book (ebook), etc.

In the case of a calendar, the hours of a day can be the plurality of members in the first-level list, and a common characteristic shared by the members can be the date. Thus, the first-level listing is hours in the same day while related second-level information can be additional information relating to an appointment within those hours, such as the name of an appointment. A third level of information can be the name of the appointment, a location for the appointment, and a list of invitees. A fourth level information can be the name of the appointment, a location for the appointment, a list of invitees, a presentation for the meeting, and text messages regarding the appointment. Note that, as the levels of information change and the level-number increases, in this embodiment, additional information is added with respect to the previous level. Also note that the first level for a calendar could change depending on implementation. For example, the first level could be a list of days in a month, or a list of months in a year. When the first level changes, the lower levels subsequently can be different types of information.

Similarly, in the case of a photo gallery, digital photographs can be the plurality of members in the first-level list, and a common characteristic shared by the members could be that they are associated with a single event, such as a birthday party. Related second-level information can include the file name, a title given to a particular photograph, and the date the photograph was taken. Third-level information could include the file name, the photograph's title, the date the photograph was taken, plus tags identifying the subject(s) in the photograph. Fourth-level information could include the file type and the file size. Note that in some situations, the next-higher level of information includes information from lower levels, but in other situations, the next-higher level of information does not include lower-level information.

In another example, in the case of an ebook, a title of the ebook is the first-level list. It should be noted here that the first-level list has only one element in it. Related second-level information can include a summary of the ebook, information related to the author, or the genre of the ebook. Third-level information could include the Chapter Headings of the ebook. Fourth-level information can include Chapter Text for a particular chapter of the ebook. It is to be noted here that in this ebook example, each level of information contains mutually exclusive information.

The electronic device displays 110 the plurality of members (first level information) on a first portion of the display. For easy visual navigation, the plurality of members can have a standard size and a standard font, which may be predefined by a user, a manufacturer, or the software application. Furthermore, the members can be displayed in a logical order such as chronological, alphabetical, or numerical. The display is divided into at least two portions: a first portion and a second portion. The first portion of the display is a navigation region that displays the plurality of members and, upon request by a user, any additional (second-level) information associated with a selected member. The second-level information associated with a member may be designed to provide a preview of a third level of information associated with the member. A user can navigate through the plurality of first-level members and select a member in a typical manner such as by using a joystick, arrow keys, a trackball, a mouse, tab and enter keys, a touchpad, a touch screen, voice control, or the like.

Based on user interaction with the electronic device as determined later in the flowchart 100, the second portion of the display displays third-level information associated with a selected member. The detailed information associated with a member may include all the information that is stored in the memory of the device for the selected member and that can be displayed on the display. In other words, the third-level may be the highest-numbered level of information for a particular member.

After the displaying of a plurality of members, the electronic device receives 115 a first user input. The user may use a finger, a stylus, a mouse, a D-pad, a keypad, or any other input mechanism, to provide the user input. The first input selects a first member from the plurality of members. The first member can be any member of the plurality of members displayed on the first portion of the display.

As a result of the selection, the electronic device enlarges 120 the first member. The device enlarges the first member to bring attention to the selected member and also has the effect of enhancing viewing of the selected member. The device may also optionally highlight 125 the first member. Highlighting may include changing color of the first member, showing a shadow under the first member, or showing a corona effect around the first member. In one embodiment, the other members of the plurality of members have a standard size and do not change in size. In another embodiment, the sizes of the surrounding members change. In one particular embodiment, the sizes of the other members gradually decrease, with the size of the member nearest to the selected member being almost as large as the size of the enlarged selected member and the size of the members on the display farthest from the selected member being the smallest (smaller than the standard size). In other words, the sizes of the other members are approximately proportional to their distance from the member that has been currently selected. This particular embodiment allows the same number of members to be visible on the display, without obstruction, both before and after enlargement of a selected member.

Then, the device displays 130 additional information (second-level) associated with the first member on the first portion of the display. The additional information can give a preview of the detailed information (final-level) associated with the first member. Alternately, the second-level information can be a second-level of information that is not a preview (or summary) of final-level information. For example, in the ebook implementation previously described, the second-level information (e.g., summary of the book, information of the author, or information about the genre of the book) is not a preview of the higher levels of information (e.g., chapter headings, chapter text).

In one embodiment, after displaying the additional information, the device determines 135 whether the input is an entry input or a selection input (in other words, whether the user has committed to a selection or not). A selection input is used to select a member and display only the additional information (second-level) associated with the selected member, and an entry input is used to display detailed information (third-level) associated with a member in addition to the additional information (second-level). For example, in a touch-screen embodiment, sliding a finger over a member (on the touch screen) without a touch action is a selection input and a touch action on the touch-screen is an entry input. Other examples of selection input and entry input are single tap and double tap, mouse-over and click of the mouse, navigating to the various members using the arrow keys on the keypad and then pressing an ENTER key, navigating to the various members using a trackball, joystick, or D-pad and pressing the ENTER key, and focusing on a members using a TAB key and pressing the ENTER key.

If the device determines 135 that the first input is an entry input, then the device displays 140 detailed information (third-level) associated with the first member on the second portion of the display. Detailed information associated with a member can be all the information associated with the member that is stored in the electronic device and accessible by the software application. In other words, the third-level can be a final level of information. For example, in the case of a calendar, the detailed information includes information, messages, and documents associated with a meeting or an appointment which is scheduled at the selected hour.

On the other hand, if the device determines 135 that the first input is not an entry input but is rather a selection input, then the device skips displaying detailed (third-level) information associated with the first member. Thus, in this case only the additional information (second-level) associated with the selected member is displayed on the first portion of the display. For example, in a device having a touch-sensitive display, if the device determines that the first input is a touch action, then in addition to enlarging the first member and displaying additional information associated with the first member on the first portion of the display, the device displays detailed information associated with the selected first member on the second portion of the display. However, if the device determines that the first input is placing a finger over the member (on the touch screen) without a touch action, then the selected member is enlarged and additional information associated with the first member is displayed on the first portion of the display.

In another embodiment, the device does not distinguish between an entry input and a selection input. Thus, after displaying the additional information (second level of information), the device (without determining the type of input) directly displays 140 the detailed information associated with the selected member. It should be noted here that, in both the embodiments described, the steps of enlarging 120 the first member, optionally highlighting 125 the first member, and displaying 130 additional information associated with the first member are performed simultaneously (or near-simultaneously).

Then, the device determines 145 if a second input has been received on the first portion of the display. If the device determines 145 that another input has been received on the first portion of the display, then the device loops back to enlarging 120 the second selected member, optionally highlighting 125 the second member, displaying 130 additional information (second level of information) associated with the second member, and so on. Additionally, the former first member is reduced back to the standard size and the additional information associated with the former first member is removed from the first portion of the display.

However, if the device determines 145 that the second input is not received on the first portion of the display, then the device checks 150 if the second input is received on the second portion of the display. If the device has not received a second input on the second portion of the display, then the device loops back to determining 145 if the device has received another input on the first portion of the display.

On the other hand, if the device determines 150 that the second input has been received on the second portion of the display, then the device performs 155 a function according to the received input. The received input, for example, may be clicking on a link displayed on the second portion of the display, editing information displayed on the second portion of the display, scrolling through information displayed on the second portion of the display, etc. After performing the function, the device again goes back to determining 145 if the device has received another input on the first portion of the display.

In this manner a user can navigate through a large number of members on a display, use a selection input to see additional information regarding a particular member, and use an entry input to see both additional information and detailed information regarding a particular member. By leaving the original list of members on a first portion of the display, a user can maintain continuity with the overall list while a second portion of the display provides the detailed information.

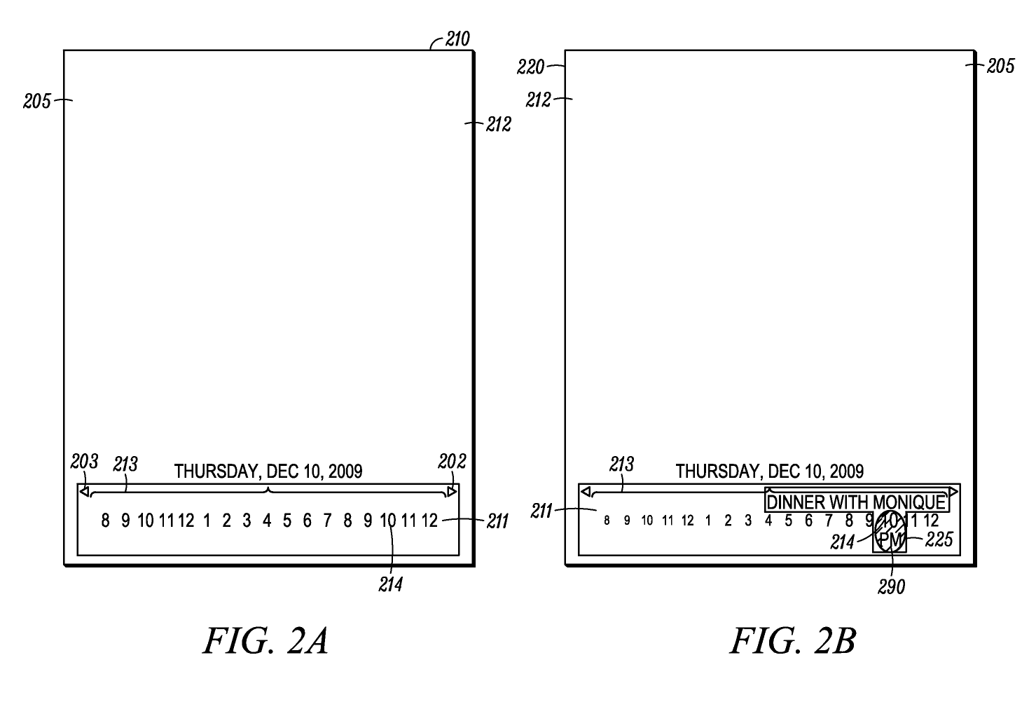

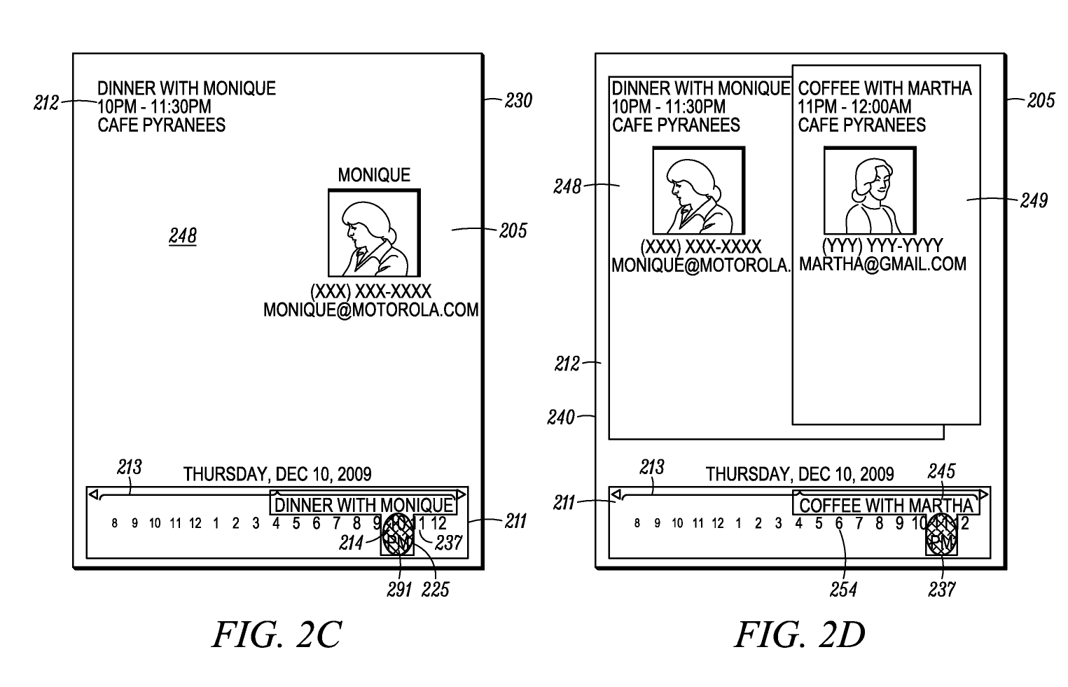

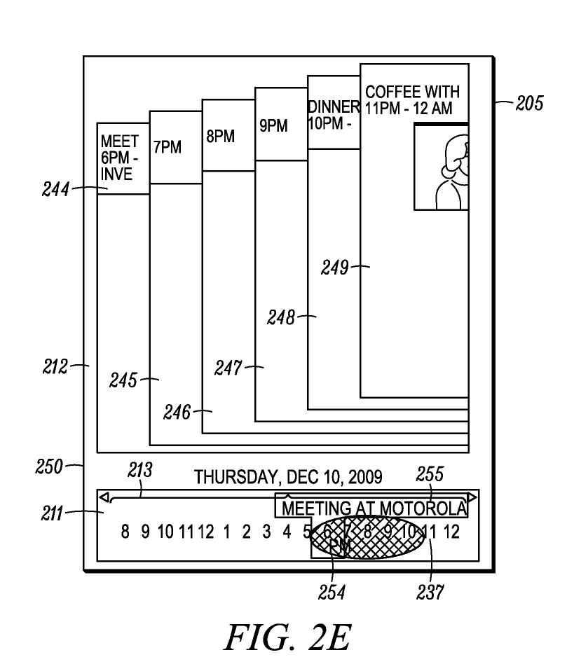

FIG. 2 illustrates screen views 210, 220, 230, 240, 250 of an electronic device demonstrating an exemplary process for displaying information on a display in accordance with some embodiments. The example of FIG. 2 illustrates a calendar software application having a one-dimensional format for displaying a navigation region. In the example of FIG. 2, hours of a day are the plurality of members in the first-level list, and a common characteristic shared by the members is the date. Related second-level information is the name and time for a scheduled appointment. Third-level information can be the complete details of the appointment such as the name of the appointment, the time for the appointment, the location of the appointment, a list of invitees, a slide presentation for the appointment, etc. Also in the example of FIG. 2, the display is a touch screen, and a touch action is the entry input and placing a finger over a member (on the touch screen) without a touch action is the selection input.

The user commences the process by selecting or entering a day in a calendar. As a result, the display 205 looks like screen view 210. The screen view 210 depicts a display 205 that includes a first portion 211 and a second portion 212. The first portion 211 of the display 205 is the navigation region that displays a plurality of members 213 (first level list). In the example of FIG. 2, the plurality of members 213 are the hours of a day starting from 8 a.m. and ending at 12 a.m. The first portion 211 of the display 205 also includes a forward arrow 202 to view the next day's members and a back arrow 203 to view the previous day's members. The second portion 212 of the display 205 can display detailed information (third-level information) associated with a selected member. In this example, detailed information includes all information associated with the selected member that is stored in the electronic device and accessible to the calendar software application. In other words, the third-level information is the final-level information. In the case of this calendar embodiment, detailed information includes contact information, messages, and documents related to the scheduled appointment. Detailed information could also include URLs, telephone numbers, and various other types of information.

In the example of FIG. 2, the user places 290 a finger above a member ‘10’ 214 displayed on the first portion 211 of the display 205 without touching the display, to provide a selection input. As a result of the placing, the screen view 210 changes to screen view 220. The selected member ‘10.’ 214 (shown in screen view 210) is enlarged. At the same time, the size of all the members 213 is also changed. The size of all the members 213 decreases gradually—with the size of the member nearest to the selected member being almost as large as the selected member 214 and the size of the member farthest from the selected member being the smallest.

In this manner, the selected member can be enlarged and yet the same list of members is visible on the first portion of the display. Also, the additional information 225 (second level of information) associated with the selected member 214 is displayed on the first portion 211 of the display 205. In the case of this calendar implementation, additional information gives a preview of the meeting scheduled at the selected hour. In the example of FIG. 2, the additional information 225 (second level of information) is “Dinner with Monique” and the starting time at which the meeting is scheduled e.g., 10 p.m. Also, because the input received at the first portion 211 is a selection input, the device does not display anything on the second portion 212 of the display. As a result of receiving a selection input, the device skips displaying the detailed information (third level of information) on the second portion 212 of the display 205.

Then, in accordance with the example of FIG. 2, the user touches 291 the member ‘10’ 214 displayed on the first portion 211 of the touch screen display 205 to create an entry input, as shown in screen view 230. As a result, a detailed description (third level of information) 248 associated with the member ‘10’ 214 is displayed on the second portion 212 of the display 205. In the example of FIG. 2, the third level of information includes the name of the appointment, the starting and ending times for the appointment, a list of the invitees with contact information, location of the appointment, and documents related to the meeting. Further, in the example of FIG. 2, the user, while touching the touch screen display 205, drags a finger from member ‘10’ 214 to member ‘11’ 237 displayed on the first portion 211 of the display 205. The screen view 240 is a transition from the displaying of the information related to the member ‘10’ 214 (shown in screen view 230) to the information related to the member ‘11’ 237 (shown in screen view 240). As shown in screen view 240, the member ‘11’ 237 is enlarged, and additional information 245 (second level of information) associated with the selected member 237 is displayed on the first portion 211 of the touch screen display 205. The second portion 212 of the display 205, illustrates the moving-out of the detailed information 249 (third level of information) associated with the member ‘10’ 214 and the moving-in of the detailed information 249 (third level of information) associated with the member ‘11’ 237. This type of visualization is known as synchronized visualization and this provides a cinematic effect to the user. The smooth and incremental transitions to the screen views 240 is in contrast to abrupt changes (such as selecting different web pages) and allows a user to maintain more navigation control and also visually understand the sequential relationships among the files of detailed information being traversed.

Then, in the example of FIG. 2, the user, while still touching the touch screen portion of the display 205, drags the finger from member ‘11’ 237 to member ‘6’ 254 displayed on the first portion 211 of the display 205. Before the displaying of the detailed information related to the member ‘6’ 254, the display 205 looks like screen view 250. In screen view 250, the intermediate members between member ‘11’ 237 and member ‘6’ 254 are visualized synchronously. Due to speed of selection, only partial information associated with the intermediate members can be seen. The screen view 250 illustrates a sequential change in detailed information (third level of information) associated with the intermediate members ‘10’, ‘9’, ‘8’, ‘7’ on the display 205, wherein each view shows additional information (second level of information) on the first portion 211 of the display and detailed information (third level of information) on the second portion 212 of the display 205 associated with each intermediate member between the member ‘11’ 237 and member ‘6’ 254. After the synchronized visualization, the member ‘6’ 254 is enlarged and the additional information 255 and complete detailed information 244 associated with member ‘6’ is displayed on the display 205 (not shown in the example of FIG. 2).

However, if the user had picked up the finger from member ‘11’ 237 and placed the finger down on the ‘6’ member 254 displayed on the first portion 211 of the display 205, then the information displayed on the display 205 would have changed abruptly and there would have been no transition of detailed information, as shown in the previous screen view 250. The display 205 initially displayed all the information, i.e. second level of information as well as the third level of information, related to the ‘11’ member 237. When the user abruptly lifts the finger from the ‘11’ member 237 and places the finger on the ‘6’ member 254, then the display 205 displays all the information related to the ‘6’ member. As a result, the display changes abruptly from one screen view to another screen view and there are no intermediate transitions involved.

In yet another situation, using a sensing technology that can detect a finger before it touches the touch-screen (i.e., detects a finger that is nearby but not physically touching the screen), the user lifts the finger from the member ‘11’ 237, moves the finger towards the ‘6’ member 254 by sliding over the intermediate members without touching the touch-screen, and finally touches the finger on the ‘6’ member 254 displayed on the first portion 211 of the display 205. In this case, intermediate members may be selected because the input received by the device for the intermediate members is a selection input. As a result, a sequential change in the additional information (second level of information) associated with the intermediate members between ‘11’ member 237 and ‘6’ member 254 are visualized synchronously in the first portion 211 of the display 205. In this case, the second portion 212 of the display 205 displays the detailed information 249 associated with the ‘11’ member 237 until the entry input of the ‘6’ member 254. And after the synchronized visualization in the first portion 211, when the user places his finger (touch action) on the ‘6’ member 254, the ‘6’ member 254 is enlarged and the additional information 255 and detailed information 244 associated with ‘6’ member 254 is displayed on the display 205.

Therefore, by using this method, the user can easily navigate to different hours (e.g., through the first-level list) present in the calendar, view the appointments and meetings scheduled at a particular time (e.g., the additional information or the second-level of information), view detailed information regarding a scheduled appointment (e.g., the third and final level of information), and also understand the sequential relationship between the plurality of members displayed on the first portion 211 of the display 205.

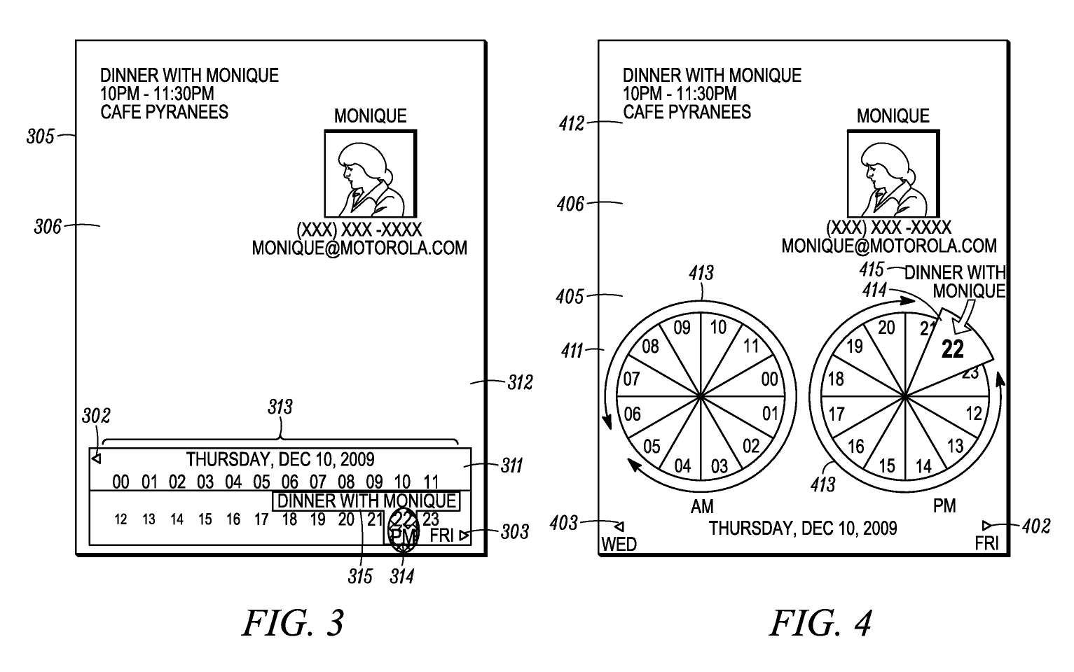

FIGS. 3-4 illustrate different formats for displaying a navigation region. In these alternative calendar software applications, the navigation regions both have a two-dimensional format rather than the one-dimensional format of FIG. 2. Also, in the example of FIGS. 3-4, a touch action is an entry input and placing a finger over a member (on the touch screen) without a touch action is a selection input. In FIG. 3, the two-dimensional format is a two-row matrix while in FIG. 4, the two-dimensional format is a circular shape. Like the implementation shown in FIG. 2, in FIGS. 3-4 the additional information associated with a member gives a preview of the detailed information for that member. The additional information is a second level of information which can include information relating to an appointment within those hours, such as name of the appointment, etc. The detailed information or the third and final level of information can include all the information associated with the member. The detailed information may include name of the appointment, start and end times for the appointment, location of the appointment, list of invitees with contact information, documents related to the appointment, etc. It should be noted here that the calendar software application can have more than three levels of information. The other levels of information may be selected based on an additional entry method. For example, for viewing only the second level of input a selection input is required. For viewing only the third level of input a touch input is required and for viewing a fourth level of input a touch input and a key press may be required.

FIG. 3 illustrates a display 305 that includes a first portion 311 and a second portion 312. The first portion 311 of the display 305 is the navigation region that displays a plurality of members 313 (first level list). In the example of FIG. 3, the plurality of members 313 are the hours of a day starting from 0000 hrs to 1100 hrs in the first row and the hours starting from 1200 hrs to 2300 hrs in the second row. Additionally, the first portion 311 of the display 305 also displays additional information 315 (second level of information) associated with a selected member 314. The first portion 311 of the display 305 also includes forward arrow 303 to view members for the next day and a back arrow 302 to view members for the previous day. The second portion 312 of the display 305 displays detailed information 306 associated with a selected member. Detailed information includes all information associated with the selected member 314 that is stored in the electronic device including links, files (documents and photographs), and text.

FIG. 3 depicts a two-dimensional format for displaying the navigation region. In this format a plurality of members 313 are displayed in a plurality of strips. The strips maybe placed horizontally or vertically on any portion of the display 305. For example, if the strips are aligned vertically on the display 305, then the strips can be placed either on the left side or on the right side of the display 305. And, if the strips are aligned horizontally on the display 305, then the strips can be aligned either at the top of the display 305 or at the bottom of the display 305.

Of course the matrix two-dimensional format shown and described can be extended to three-dimensional formats. Alternately, non-matrix two-dimensional formats can be used.

FIG. 4 depicts another two-dimensional format; this embodiment, however, uses two circular icons for displaying the navigation region instead of a two-row matrix. In this example of FIG. 4, the plurality of members 413 are the hours of a day from 0000 hrs to 1100 hrs in the first circular icon and the hours from 1200 hrs to 2300 hrs in the second circular icon. Yet another variation could use a single circular shape for all 24 hours of a day, or just show a 12-hour clock-type shape for either the morning or the evening. FIG. 4 illustrates a display 405 that includes a first portion 411 and a second portion 412. The first portion 411 of the display 405 is the navigation region that displays a plurality of members 413. In the example of FIG. 4, the plurality of members 413 are the hours of a day starting from 0000 hrs and ending at 2400 hrs. Additionally, the first portion 411 of the display 405 can display additional information 415 associated with a selected member 414. The first portion 411 of the display 405 includes a forward arrow 402 to view members for the next day and a back arrow 403 to view members for the previous day. The second portion 412 of the display 405 can display detailed information 406 associated with a selected member 414. Detailed information includes all information associated with the selected member that is stored in the electronic device. In the example of FIG. 4, ‘2200’ member 414 is a selected member, therefore the ‘2200’ member 414 occupies a greater area relative to the standard sizes of the non-selected members. Note that, in this embodiment, the non-selected members maintain their standard size. It should also be noted that a navigation region may include other types of formats such as: a zig-zag format, an angular format, a semi-circular format, etc. This facilitates easy viewing and selection from the plurality of members.

In addition to calendar and other scheduling software applications, the method and apparatus for displaying information in an electronic device can be used for many other types of applications.

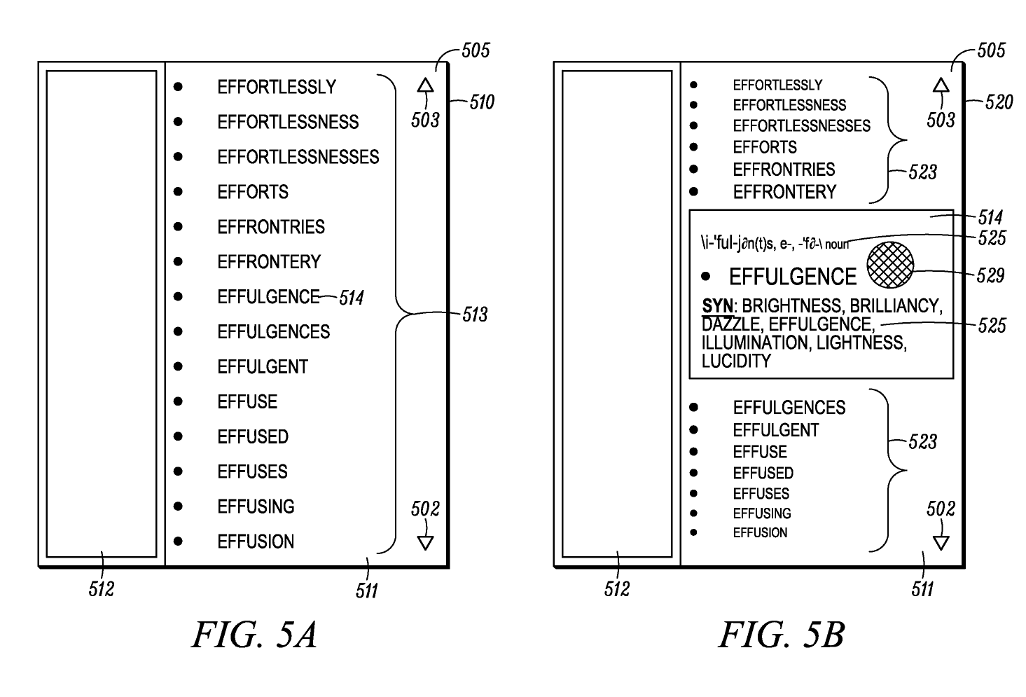

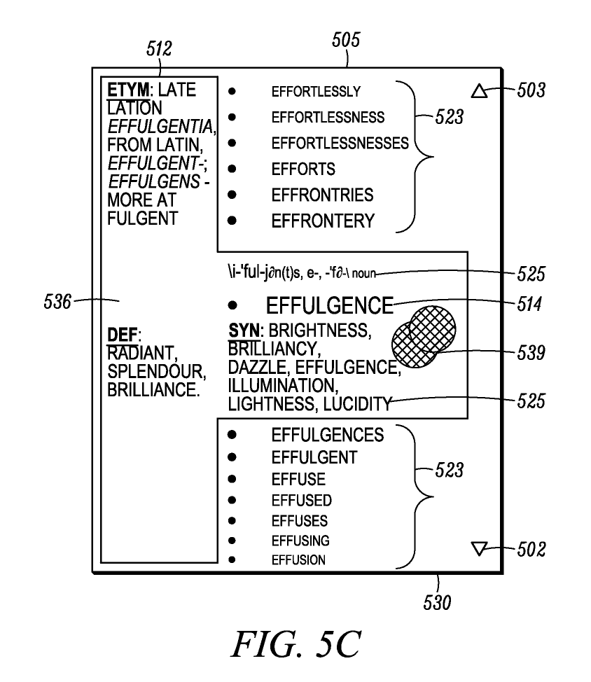

FIG. 5 illustrates screen views 510, 520, 530 of an electronic device demonstrating an exemplary process for displaying information associated with a word, present in an electronic dictionary software application, on a display 505 in accordance with some embodiments. In the example of FIG. 5, words in the electronic dictionary software application are the plurality of members in the first-level list, and a common characteristic shared by the members is that they are words arranged in alphabetical order. Related second-level information for a selected word is pronunciation of the word, meaning of the word, and synonyms of the word. A third level of information can be etymology of the word and definition of the word. In this case, the first-level, second-level, and third-level of information do not overlap. In the example of FIG. 5, a double tap on the touch screen display is the entry input and a single tap on the touch screen display is the selection input.

The user commences the process by invoking the electronic dictionary software application in the electronic device. The user may then search the dictionary by typing a string such as “effortl” in a search window (not shown), using a real or virtual keypad. As a result, the display 505, looks like screen view 510. The display includes a first portion 511 and a second portion 512. On the first portion 511 a plurality of words 513 are displayed. It should be noted here that the first portion 511 of the display 502 displays a fixed number of words. The number of words may be determined based on the font size of each word. The plurality of words 513, in the example of FIG. 5, include words that start with ‘effortl’ and all the words that follow ‘effortl’ in a dictionary and can be displayed on the first portion 511. Arrows 502, 503 can be used to scroll through the plurality of member words. On a second portion 512 detailed information associated with a selected word can be displayed. The plurality of words 513, in the example of FIG. 5, are displayed alphabetically. In screen view 510, the second portion 512 of the display 505 does not show any information because the user has just received search results from the dictionary application and has not selected any word. In another embodiment, detailed information associated with the first member, e.g., “effortlessly” in the example of FIG. 3, may be displayed in the second portion 512 of the display 505 by default.

The user then, in the example of FIG. 5, single-taps 529 the word ‘effulgence’ 514 using a finger or stylus. As a result, the screen view 510 changes to screen view 520. As shown in screen view 520, the word “effulgence” 514 is enlarged and additional information 525 (second-level information) associated with “effulgence” 514 is displayed on the first portion 511 of the display 505. In the example of FIG. 5, the additional information 525 associated with a word may include the pronunciation of the word, type of word, and the synonyms of the word. Also, the sizes of adjacent words 523 are changed. The sizes of the words decrease gradually with the size of the word nearest word to the enlarged word having a size almost same as the size of the enlarged word and the size farthest from the enlarged word having a minimum size (smaller than the standard size). The line spacing of the words can also change. In this manner, the selected word can be enlarged while the same members are visible on the first portion 511 of the display 505. Because in the example of FIG. 5, the single-tap is considered a selection input and not an entry input, only the additional information 525 associated with the word is displayed on the first portion 511 of the display 505.

The user then, in the example of FIG. 5, double-taps 539 the word ‘effulgence’ 514 using a finger or a stylus. As a result, the screen view 520 changes to screen view 530. Because in the example of FIG. 5 a double-tap is considered an entry input, detailed information (third level of information) 536 associated with the word ‘effulgence’ 514 is displayed in the second portion 512 of the display 505. In screen view 530, the word ‘effulgence’ 514 is enlarged and additional information 525 is displayed on the first portion 511 of the display 505. Plus, detailed information 536 associated with the word ‘effulgence’ 514 is displayed on the second portion 512 of the display 505. The detailed information in the case of this dictionary software application includes etymology of the word and meaning of the word. Additionally, another level of information may also be included. This fourth level of information can include antonyms of the word or translations of the word in other languages such as Latin or Greek accessible using yet another type of input interaction. Therefore using this method, the user can easily navigate through words in a dictionary software application, view information associated with a selected word, and understand how the words are sequentially related (alphabetically, in this example).

The user could have gone from screen view 510 directly to screen view 530 simply by double-tapping the member “effulgence” 514. Also, the synchronized visualization previously described with respect to FIG. 2 may be applied to this dictionary software application such that a user can slide a finger up and down within the first portion 511 to obtain larger-font versions of the selected words along with their related additional information. The user could then double-tap a desired word to have its detailed information shown in the second portion 512 as shown in screen view 530.

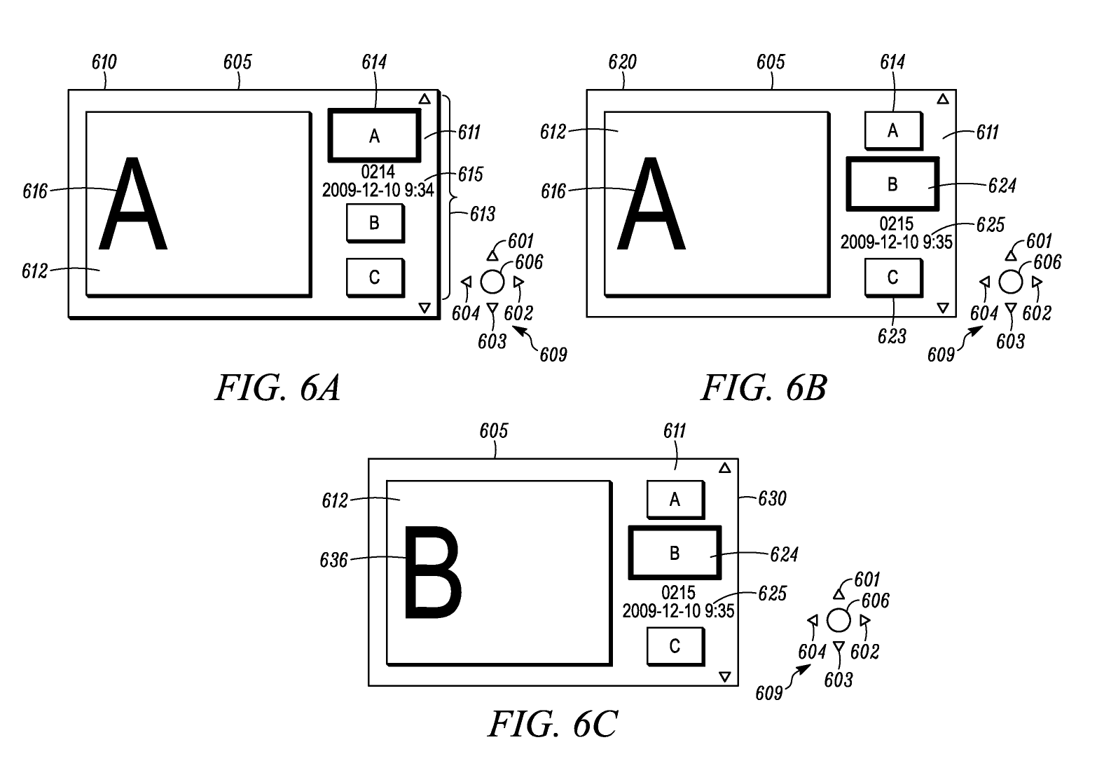

FIG. 6 illustrates screen views 610, 620, 630 of an electronic device demonstrating an exemplary process for displaying information associated with a picture, in a photo gallery software application, on a display 605 of an electronic device in accordance with some embodiments. In the example of FIG. 6, thumbnail pictures in the photo gallery software application are the plurality of members that form a first-level list, and a common characteristic shared by the pictures is that they are from a single event, for example a trip to Singapore. Related second-level information of a selected picture is a name of the photograph and a time when the photograph was taken. A third level of information of the thumbnail photograph is the full view of the photograph. A fourth level of information may include the names of people tagged in the photograph, size of the photograph, the place where the photograph was taken, or any further detailed information related to the photograph.

In the example of FIG. 6, a navigation cluster 609 is also shown. The navigation cluster includes a central key 606, up key 601, right key 602, down key 603, and left key 604. The pressing of the up key 601, down key 603, right key 602, or left key 604 is perceived as the selection input by the electronic device and the pressing of the central key 606 is perceived as the entry input by the electronic device, in this example.

The process commences with a user invoking the photo gallery software application and then selecting the folder in which all the photographs of the trip to Singapore are saved. As a result, one or more thumbnails of the trip to Singapore are displayed on the display 605. By default, the software application provides a first input that selects and enters the first thumbnail from the one or more thumbnails displayed on the display 605. As a result of the entering, the display 605 look like screen view 610. The display 605 in the screen view 610 includes a first portion 611 on which a plurality of thumbnails 613 are displayed and a second portion 612 on which a full-view photograph associated with the selected thumbnail is displayed. The thumbnails are displayed in a sequential order, that is, in order of the time at which they were taken. In screen view 610, because the software application has, by default, already selected the first thumbnail 614 the additional information (second level information) 615 associated with the thumbnail 614 is displayed adjacent to the thumbnail. The additional information 615 in this embodiment includes the name of the photograph and the date and time when the photograph was taken. Further, because the previous default input was an entry input, in screen view 610 the photograph ‘A’ 616 is displayed in full view in the second portion 612 of the display 605. Additionally, the thumbnail 614 associated with photograph is enlarged and has a shadow effect. In some other embodiments, the thumbnail of ‘A’ may have a different color, or a corona effect around the thumbnail. These effects are helpful in bringing attention to the selected member.

Then, in the example of FIG. 6, the user presses the down key 603 once to select the thumbnail photograph ‘B’ 624. As a result, the screen view 610 changes to screen view 620. In screen view 620, the thumbnail associated with the photograph ‘B’ 624 is enlarged while the previously selected member 614 is reduced back to standard thumbnail size. Additionally, the thumbnail of ‘13’ 624 has a shadow effect. Also, the additional information 625 associated with the thumbnail photograph 624 is displayed on the first portion 611 of the display 605. Additional information 625 includes the name of the photograph and the date and time when the photograph was taken. Other implementations could include the size of the file, the names of the people tagged in the photograph, and/or the place where the photograph was taken. It should also be noted that because the user uses the down key 603 to select the thumbnail 624, the device determines that the input is a selection input and not an entry input. Therefore, the device does not change the photograph in the second portion 612 of the display 605. As shown in screen view 620, the second portion 612 of the screen 605 still shows the photograph ‘A’ 616. Also, in the example of FIG. 6, the other thumbnail 623 does not change in size. At this point, in the example of FIG. 6, the user presses the central key 606. As a result, the screen view 620 changes to screen view 630. In screen view 630, because the user pressed the central key 606, the device determines that the input is an entry input. Therefore, in response to the determination, the full-size photograph ‘A’ 616 shown in screen view 620 is replaced by full-size photograph ‘B’ 636, as shown in screen view 630. However, the first portion 611 of the display 605 in screen view 630 remains unchanged relative to screen view 620.

In the example of FIG. 6, if the user repeatedly presses the combination of the down key 603 followed by the central key 606, then there is a sequential change in thumbnails that are highlighted. (Additionally, when a thumbnail is highlighted, the additional information of the highlighted thumbnail is displayed adjacent to the highlighted thumbnail.) When the user input is an entry input as a result of pressing the central key 606, there is a sequential change in the full-view photographs displayed on the second portion 612 of the display 605. The sequential change in the full-view photographs is shown as the moving-in of a presently-entered photograph and the moving-out of the previously entered photograph, similar to the FIG. 2 screen views 240 and 250. This synchronized visualization provides a cinematic effect to the user and also gives a smooth and an incremental transition to the full-view photographs and allows the user to maintain more navigation control among the photographs displayed on the display.

Moreover, when the user wants to view a fourth or a further level of information, then in one embodiment the user may place a cursor over the thumbnail member, the additional information, or the detailed information. As a result, the fourth level information having the names of people tagged in the photograph, size of the photograph, the place where the photograph was taken, or any other information related to the photograph is displayed either in a bubble adjacent to the cursor or a specific location on the second 612 portion of the display 605.

Thus, the user is able to easily navigate through various photographs, view a desired level of information associated with a photograph, and understand the sequential relationship between the various photographs of an event.

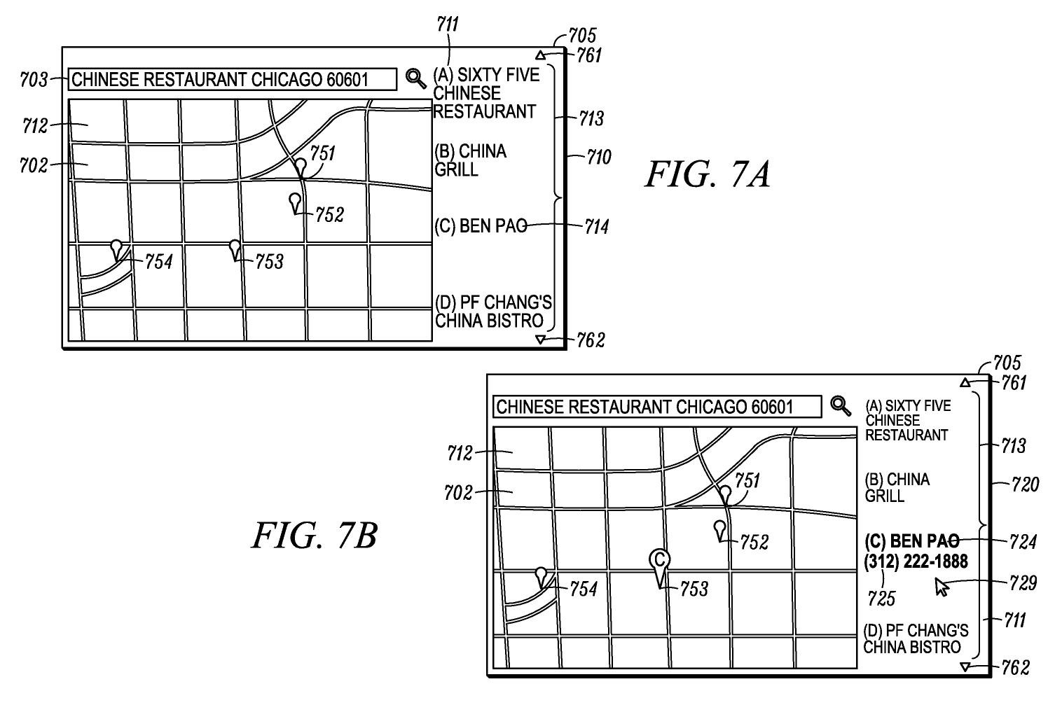

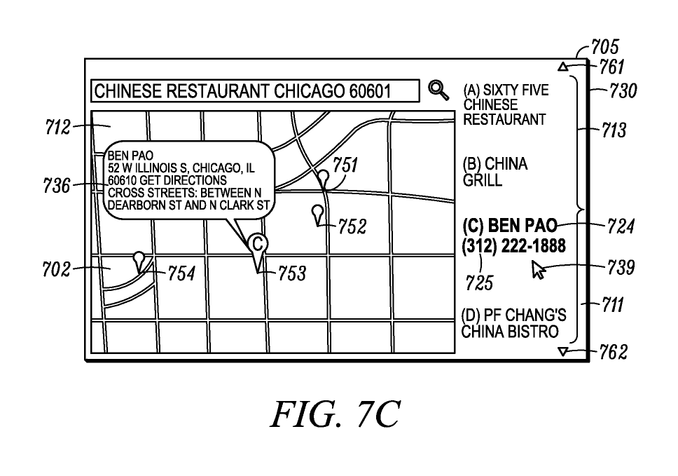

FIG. 7 illustrates screen views 710, 720, 730 of an electronic device demonstrating an exemplary process for displaying information associated with a place shown in a web map software application in accordance with some embodiments. In the case of a web map software application, a first-level of information is a list of places. The list of places includes one or more places of interest. Related second level of information can be additional information related to a selected place of interest. The additional information or the second level of information may include a telephone number of the place of interest. A third level of information may include the name and address of the place of interest, and other relevant information related to the place of interest. It is to be noted that, in this case, each level of information is mostly non-overlapping with the other levels or, in other words, each level of information contains a different set of information except for the name. Also, in this case the mouse-over is a selection input, which when inputted displays the second level of information; and a mouse-click is an entry input which when inputted displays the third level of information. It should be noted that any other input or combination of inputs, such as key press or mouse double-click, can be used to display a fourth level of information.

The screen view 710 illustrates a display 705 after the user enters a web map software application. The display 705, in the example of FIG. 7, has a search window 703 which allows a user to search for a place of interest. For example, the user may wish to view Chinese restaurants situated in Chicago. When the user enters the required search string using a real keypad, a virtual keypad, or voice command (for example), then the device displays all the places related to that search string. As shown in screen view 710, the search string entered by the user is “Chinese restaurant Chicago 60601” 703. As a result, the device displays Chinese restaurants 713 situated in the Chicago area on the first portion 711 of the display 705. The device also displays a web map 702 of the Chicago area in the second portion 712. Additionally, the device also displays small markers 751, 752, 753, 754 to show the geographic location of the Chinese restaurants situated in the area on the web map 702. The first portion 711 of the display 705 also includes a forward arrow 761 to view any prior members of the resulting set of Chinese restaurants and a back arrow 762 to view any subsequent members of the resulting set of Chinese restaurants.

Then, the user may choose one of the restaurants displayed on the first portion 711 of the display 705 by bringing the cursor over one of the restaurants and clicking the right button of the mouse, thereby “entering” the restaurant. In the example of FIG. 7, the user using a mouse moves the cursor over the restaurant ‘Ben Pao’ 714 displayed on the first portion 711 of the display 705. As a result, the font size of the name of the restaurant enlarges, as shown in screen view 720. Plus, additional information 725 associated with the selected restaurant 724 is displayed on the first portion 711 of the display 705. The additional information 725 (or second level of information) shown is the telephone number of the restaurant. Alternately or additionally, the additional information could be the rating of the restaurant and an address of the restaurant. In addition, the marker 753 associated with the selected restaurant is also enlarged and/or highlighted, so that the user can easily view the exact location of the restaurant on the web map 702.

Alternatively, the user may select one of the markers 753 from the screen view 710, by bring the cursor over the place of interest. As a result, the marker 753 is enlarged and the name of the selected restaurant ‘Ben Pao’ 724 displayed on the first portion 711 of the display 705 is enlarged, as shown in screen view 720. Also, the additional information 725 of the selected restaurant 724 is displayed on the first portion 711 of the display 705. Note that, in this example the size of the non-selected members is gradually reduced.

Then, as shown in the example of FIG. 7, the user using the mouse clicks 739 over the name of the restaurant 724 displayed on the first portion 711 of the display 705, as shown in screen view 720. As a result, detailed information 736 associated the restaurant appears next to the marker 753 for the selected restaurant 724 on the second portion 712 of the display 705, as shown in screen view 730. The detailed information 736 includes the name and address of the restaurant, and other relevant information related to the restaurant. Therefore, using this technology the user can easily view information related to a particular place on a web map.

Alternatively, the user may click on one of the markers 753 from the screen view 710. As a result, the device may display detailed information 736 about the place in a bubble adjacent to the selected marker 753, as shown in screen view 730. In another embodiment, the detailed information may be displayed on a predetermined part of the second portion 712 of the display 705, such as the lower margin.

Therefore, using this technology the user can not only view a place of interest on a web map but also view several layers of relevant information related to the place of interest. Additionally, the user is also able to view related places of interest and navigate from one member to another without getting disoriented.

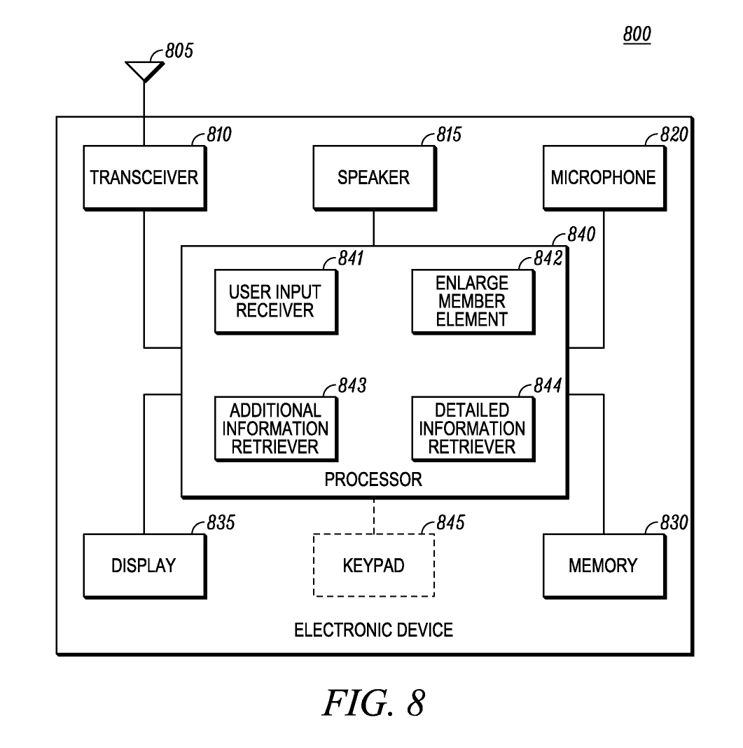

FIG. 8 is a block diagram 800 of an electronic device for displaying information in accordance with some embodiments. In the example of FIG. 8, the electronic device includes a display 835, an optional fixed keypad 845, a microphone 820, a speaker 815, an antenna 805, a transceiver 810, a memory 830, and a processor 840 coupled to all other parts of the electronic device 800. The processor 840 further includes a user input receiver 841, an enlarge member element 842, an additional information retriever 843, and detailed information retriever 844.

The keypad 845 may be optionally present in the electronic device 800 and/or the display 835 could be a touch screen. The keypad 845 is a conventional keypad with various fixed keys for receiving user input. The keypad 845 includes arrow keys that help move the cursor in all directions. The microphone 820 is responsible for converting received audio signals from a user of the electronic device 800 into electrical signals for transmission, and the speaker 815 is responsible for converting incoming electrical signals into audio signals for the user of the electronic device 800. The transceiver 810 is used for transmitting and receiving the signals to another device (not shown) using the antenna 805. The memory 830 is used for storing data and instructions.

The display 835 in this embodiment includes a touch screen portion and a non-touch screen portion. Of course, the display could completely be a touch screen with a portion deactivated to act as a non-touch screen (display-only) portion. Alternately, two separate displays (one display-only and one touch screen) could be used. On the touch screen portion of the display 835, the processor 840 may display a plurality of members and additional information associated with one of the plurality of members. For example, members could be words of a dictionary, thumbnail photographs of a photo gallery, tagged places in a map, etc. On the non-touch screen portion of the display 835, the processor 840 may display detailed information associated with a selected member. For example, in the case of a dictionary, if a word is entered then the detailed information associated with the selected word could include the etymology of the word, the definition of the word, plus antonyms and synonyms of the word.

The processor 840 includes a user input receiver 841 which determines that an input is received from a user. The user may use a finger, a stylus, or a cursor to provide the user input on the first portion of the display 835 or on the keypad 845. In one example, the user may place the finger, the stylus, or the cursor above a member displayed on the display 835 without touching the display 835. In another example, the user may touch the member displayed on the display 835 using the finger or the stylus. The user may also have the option of navigating through the various members using the keypad 845 and then entering a selected member. The user also has the option of using a mouse to navigate through the various members and then clicking the mouse on a selected member to enter the selected member. Then based on the user input, the enlarge member element 842 enlarges the selected member to a predetermined size. Additionally, the enlarge member element 842 can also change the color of the first member, show a shadow under first member, or show a corona effect around the first member. Also, in some embodiments the enlarge member element 842 changes the size of all the members displayed on the display 835. The size of the enlarged selected member would be the maximum and the sizes of the other members would gradually decrease with the size of the member nearest to the enlarged member being almost same as the size of the enlarged member and the size of the member farthest from the enlarged member being the minimum. This helps bring attention to the selected member while keeping all the members visible on the display 835.

The additional information retriever 843 in the processor 840 retrieves additional information associated with the selected member from the memory 830 and displays the retrieved information adjacent to the selected member, on the first portion of the display 835. User input receiver 841 also determines if the user input is a selection input or an entry input. If an entry input is determined, the detailed information retriever 844 retrieves the detailed information associated with the selected member and displays the retrieved information on the second portion of the display 835.

As a result of using this technique, the user is able to easily navigate through a plurality of members displayed on a display and view multiple levels of information associated with the plurality of members. This allows a user to obtain a desired level of detail regarding a member using a limited amount of screen space. For example, in one case, consecutive levels of information may contain all the information from the previous levels as in the case of a calendar software application described. However, in another case, consecutive levels of information may not contain any information from the previous levels, i.e. each level contains a different set of information as in case of the dictionary software application described. In yet another case, consecutive levels of information may include some information but not all the information from the previous levels as in case of the web map software application described.

Further, by using various combinations of inputs, different levels of information can be displayed. For example, a selection input may be used to display a second level of information, an entry input may be used to display a third level of information, and another type of input (e.g., a triple-click or left-mouse-button click) may be used to display a fourth level of information. It should be noted here that the present technology not only deals with the problem of a small screen per se but also solves the problem of displaying information associated with a member when there are a large number of members and/or a lot of information associated with any particular member.

The various levels of information in different embodiments illustrate various methods of displaying a desired level of information. These various levels of information can be used in computers, mobile devices, remote controllers, etc. For example, in a computer the user may use the mouse-over and mouse-click or navigation keys and enter key present on the keyboard (or any other combination thereof) as a method for selecting and entering a member. In case of a mobile device having a touch display, the user may use the touch action as an entry input and placing the finger over a member (on the touch screen) without a touch action as a selection input, or the user can use a single tap as a selection input and a double tap as an entry input. In another embodiment, the display may not be a touch display; in that case the user may use the pressing of the navigation keys for selecting a member and pressing the central key for entering a member. It should be noted that in an embodiment, any combination of the above listed inputs may be used to display a desired level of information. Similarly, in case of remote controllers, a user can use the navigation keys and the enter key to display different level of information of a television electronic program guide. As mentioned previously, the problem is not a small screen per se, but rather that there is more information regarding one or more of the first-level members than can reasonably viewed on a single screen. Therefore, changing screens (like changing web pages) can be disorienting, and so the method and apparatus for displaying information in an electronic device uses concepts such as synchronized visualization to gradually vary selected members and gradually provide more detailed layers of information as requested by the user.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for displaying information in an electronic device, the method comprising:
displaying a plurality of members on a first portion of a display;
receiving a first input, wherein the first input selects a first member from the plurality of members;
enlarging the first member within the first portion of the display; and
displaying additional information associated with the first member on the first portion of the display.

2. The method of claim 1, wherein the first input is received on the first portion of the display.

3. The method of claim 1 further comprising:
determining if the first input is an entry input; and
displaying detailed information associated with the first member on a second portion of the display, if the first input is an entry input.

4. The method of claim 3, wherein the entry input is a touch action.

5. The method of claim 1, wherein in the displaying further comprises:
displaying each of the plurality of members in a standard size.

6. The method of claim 5 further comprising:
receiving a second input on the first portion of the display, wherein the second input selects a second member from the plurality of members;
enlarging the second member within the first portion of the display; and
displaying additional information associated with the second member on the first portion of the display.

7. The method of claim 6 further comprising:
reducing the first member to the standard size; and
removing the additional information associated with the first member from the first portion of the display.

8. The method of claim 6 further comprising:
displaying detailed information associated with the second member on a second portion of the display, if the second input is an entry input.

9. The method of claim 6, wherein a first plurality of members are present between the first member and the second member.

10. The method of claim 9 further comprising:
showing a sequential change in views on the display, wherein each view shows additional information on the first portion of the display and detailed information on a second portion of the display associated with each member from the first plurality of members, if the first input is an entry input and the second input is an entry input.

11. The method of claim 9 further comprising:
showing an abrupt change in view from a first view to a second view on the display, wherein the first view shows additional information on the first portion of the display and detailed information on a second portion of the display associated with the first member and the second view shows additional information on the first portion of the display and detailed information on the second portion of the display associated with the second member, if the first input is an entry input and the second input is an entry input.

12. The method of claim 9 further comprising:
showing a sequential change in views on the display, wherein each view shows additional information on the first portion of the display associated with each member from the first plurality of members, if the second input is not an entry input.

13. The method of claim 1, further comprising:
highlighting the first member, after the receiving a first input, wherein highlighting includes changing color of the first member, showing a shadow under the first member, or showing a corona effect around the first member.

14. The method of claim 1, wherein the plurality of members is displayed in a linear format, a two-dimensional format, or a circular format.

15. The method of claim 1, wherein enlarging the first member further comprises:
varying a size of the plurality of members neighboring the first member, wherein the number of the plurality of members displayed on the first portion of the display remains constant.

16. The method of claim 1, wherein the plurality of members is associated with at least of one of: a scheduler, a photo gallery, a dictionary, and a map.

17. An electronic device for displaying information, the electronic device comprising:
a display including a first portion and a second portion;
a user input component; and
a processor, coupled to the display and the user input component, the processor including:
a user input receiver, for receiving a user input that selects a first member from a plurality of members displayed on the first portion of the display and for determining if the user input is an entry input;
an enlarge member element, for enlarging the first member on the display;
an additional information retriever, for retrieving additional information associated with the first member from a memory and displaying the retrieved additional information on the first portion of the display; and
a detailed information retriever, for retrieving detailed information associated with the first member from the memory and displaying the retrieved detailed information on the second portion of the display, if the user input is an entry input.

18. The electronic device of claim 17, wherein the retrieved additional information is displayed adjacent to the first member.

19. The electronic device of claim 17, wherein the display comprises:
a touch screen portion; and
a non-touch screen portion.

20. The electronic device of claim 19, wherein the touch screen portion includes the first portion of the display.
